(19) United States
(12) Patent Application Publication
(10) Pub. No.: US 2024/0123996 A1
(43) Pub. Date: Apr. 18, 2024

(54) METHODS AND SYSTEMS FOR TRAFFIC LIGHT LABELLING VIA MOTION INFERENCE

(71) Applicant: Motional AD LLC, Boston, MA (US)

(72) Inventors: Holger CAESAR, Boston, MA (US); Whye Kit FONG, Singapore (SG); Abirami SRINIVASAN, Singapore (SG); Dimitrios Panagiotis GEROMICHALOS, Singapore (SG)

(21) Appl. No.: 18/146,364

(22) Filed: Dec. 24, 2022

Related U.S. Application Data
(60) Provisional application No. 63/416,248, filed on Oct. 14, 2022.

(51) Int. Cl. B60W 40/04; B60W 30/18; B60W 60/00

(52) U.S. Cl. CPC B60W 40/04; B60W 30/18154; B60W 60/0011; B60W 60/00274; B60W 2554/4029; B60W 2554/4041; B60W 2554/4044; B60W 2554/80; B60W 2555/60; B60W 2556/10; B60W 2556/40

(57) ABSTRACT

Provided are methods for offline perception motion inference, which can include obtaining map data indicative of an environment and obtaining data associated with at least one agent. The method can include determining a trajectory for the agent and matching the trajectory of the agent with a lane connector. The method can also include determining a traffic light parameter. Systems and computer program products are also provided.

The present application claims priority/benefit from U.S. Provisional Application No. 63/416,248, filed on Oct. 14, 2022, entitled “METHODS AND SYSTEMS FOR PERCEPTION MOTION INFERENCE,” which is herein incorporated by reference in its entirety.

### BACKGROUND

It is critical for autonomous vehicles to be able to determine the status of traffic lights (e.g., whether the traffic light is green or red) in their environment during operation. Radio and image-based analysis is currently being used for detecting the status of a traffic light. However, radio communication, such as dedicated short-range communication (DSRC), is not available for all traffic lights. Moreover, image-based detection only covers visible traffic lights, and requires specific hardware for use. It can be difficult to determine the status of a traffic light using only these technologies.

### BRIEF DESCRIPTION OF THE FIGURES

FIG. 1 is an example environment in which a vehicle including one or more components of an autonomous system can be implemented;

FIG. 2 is a diagram of one or more example systems of a vehicle including an autonomous system;

FIG. 3 is a diagram of components of one or more example devices and/or one or more example systems of FIGS. 1 and 2;

FIG. 4 is a diagram of certain components of an example autonomous system;

FIGS. 5A-5B are diagrams of an example implementation of a process for offline perception motion inference;

FIG. 6 is a diagram of an example implementation of a process for offline perception motion inference;

FIG. 7 is a diagram of an example implementation of a process for offline perception motion inference; and

FIG. 8 is a flowchart of an example process for offline perception motion inference.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement perception motion inference, such as for the determination of traffic light statuses (e.g., states). For example, the present disclosure relates to systems, methods, and computer program products that provide for traffic light inferences based on determined trajectories of agents. In certain examples, the disclosure includes obtaining data indicative of the environment around an autonomous vehicle, as well as data associated with agents in the environment. The disclosure further includes determining trajectories for said agents, and then matching the trajectories with known lane connectors for determination of a traffic light statuses.

By virtue of the implementation of systems, methods, and computer program products described herein, the disclosed techniques provide for the determination of traffic light statuses, e.g. via perception motion inference. Some embodiments of the present disclosure allow for online perception motion inference based on sensor data generated for operation of an autonomous vehicle. Some embodiments of present disclosure allow for offline perception motion inference, which can utilize powerful perception systems for training of a model to improve inferences and is not limited by on-car hardware constraints. Some of the advantages of these techniques include improving the determination of traffic signals, especially for non-visible traffic lights and traffic lights lacking radio communication systems. This can advantageously optimize operation of an autonomous vehicle by eliminating a speed bottleneck in repeated matching of motion trajectories and lane connectors. Further, these techniques can allow for improved labelling of traffic lights by inferring them from past and future trajectories of surrounding agents. Additionally, past and future sensor data and/or prediction data can be used in hindsight analysis for improving tracking performance, especially in the first few frames of data when tracking confidence may be low. Such perception techniques can be used for both red light and green light inferences. Moreover, the present disclosure can be used for automatically labelling the status of a traffic light in a scene by inferring the status from the past and future trajectories of surrounding agents and/or actors. Further, using past and future trajectories of agents, the disclosure allows for the determination of traffic light status for all lanes in a given intersection, and not just a single lane.

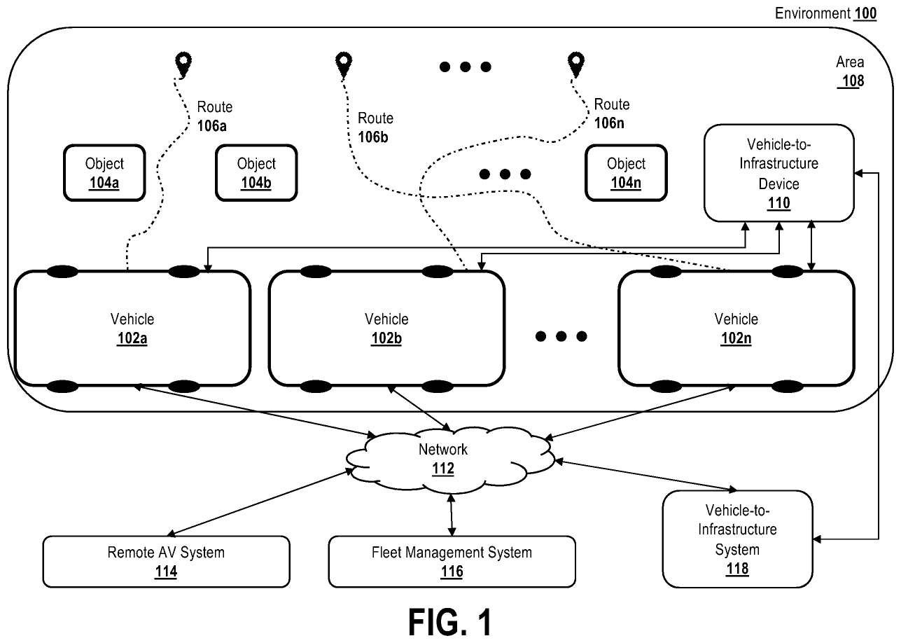

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

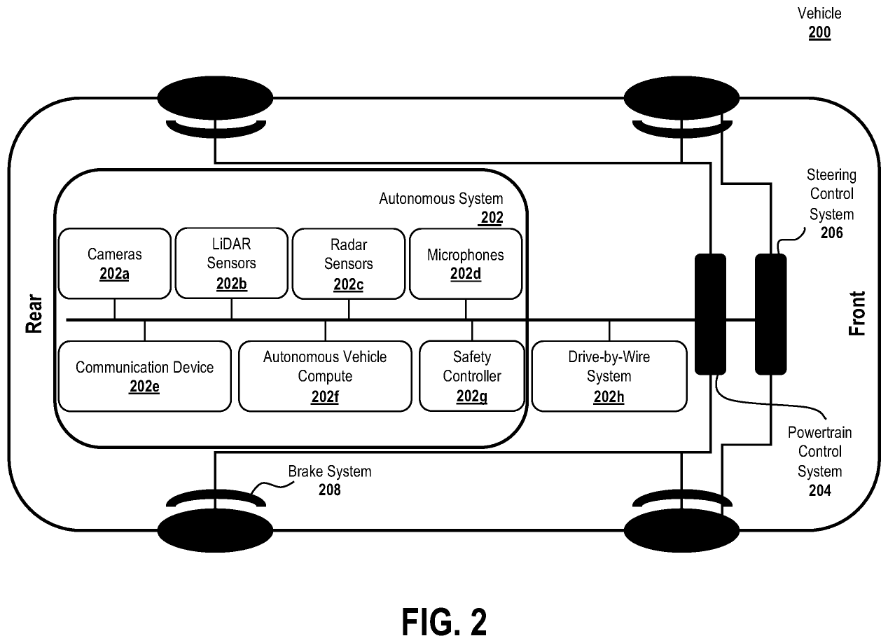

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

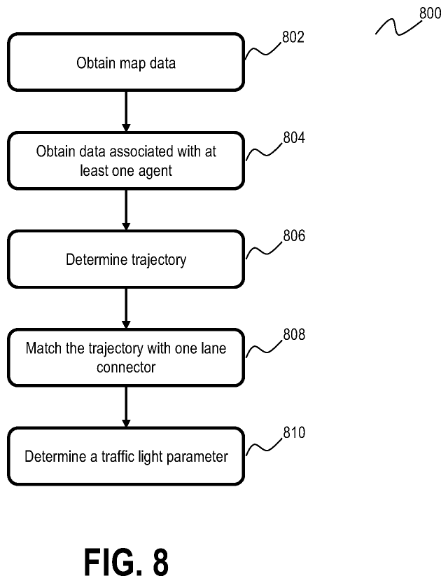

In some embodiments, device 300 is configured to execute software instructions of one or more steps of the disclosed method, as illustrated in FIG. 8.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

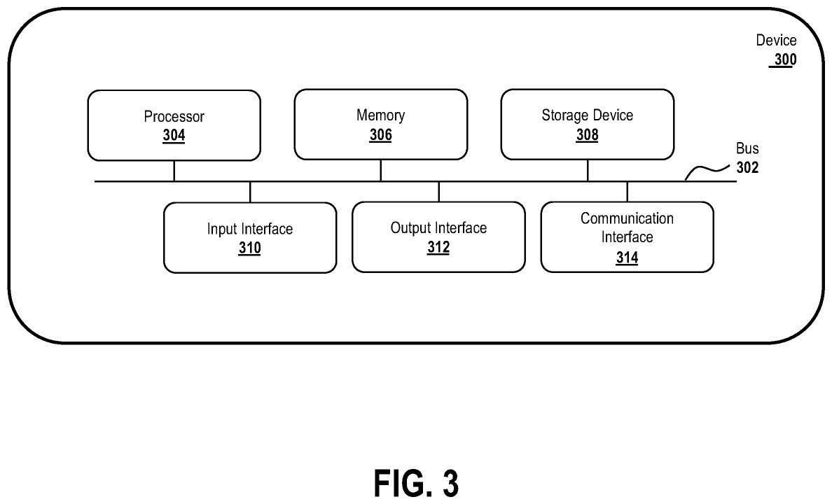

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

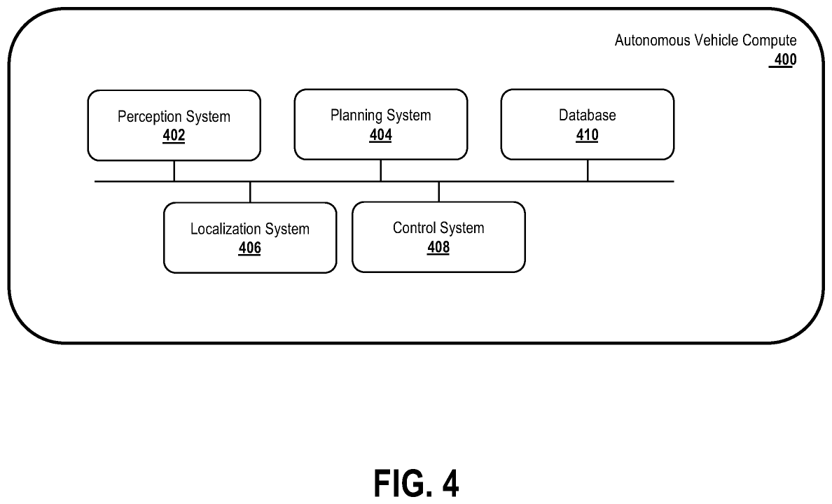

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

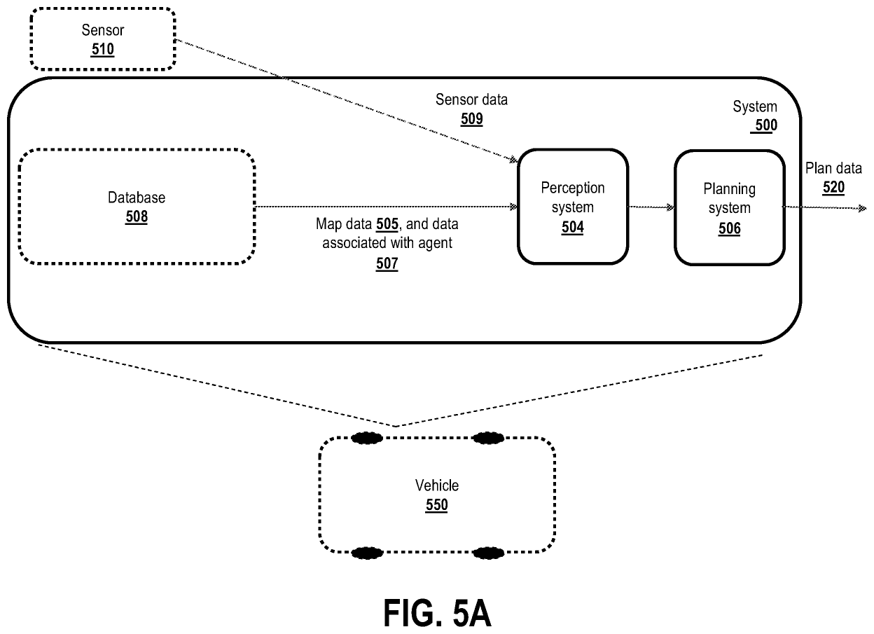

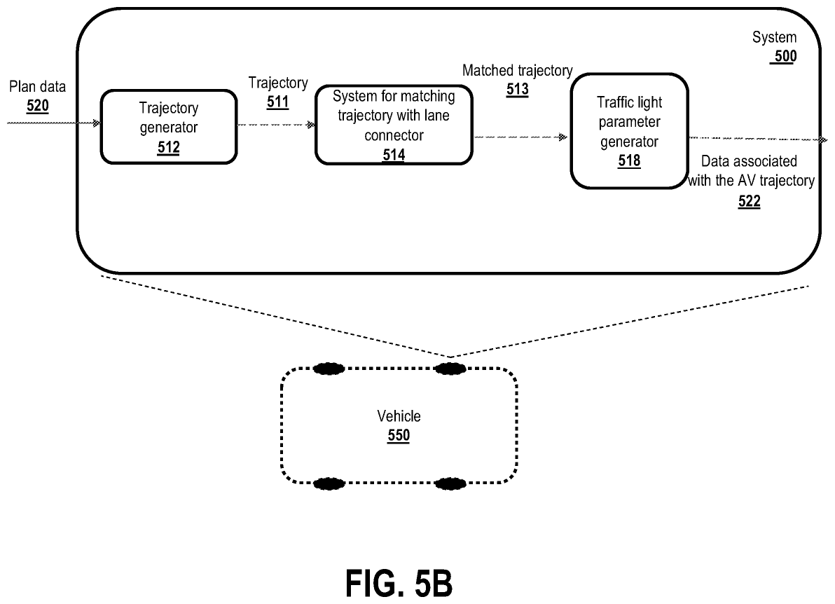

Referring now to FIGS. 5A-5B, illustrated is a diagram of a system 500 according to this disclosure. The system 500 is a system for determining a traffic light parameter (e.g., state) based on the motion of one or more agents (referred to herein as perception motion inference) in some embodiments. The system 500 is a system for determining a traffic light parameter (e.g., state) during offline (post-drive) analysis of a drive log or during online (real-time) operation of an autonomous vehicle in some embodiments. In some embodiments, system 500 is connected with and/or incorporated in a vehicle 550 (e.g., an autonomous vehicle that is the same as, or similar to, vehicle 200 of FIG. 2). In one or more embodiments or examples, system 500 is in communication with and/or a part of an autonomous vehicle (e.g., such as autonomous system 202 illustrated in FIG. 2, device 300 of FIG. 3), an AV system, an AV compute (such as AV compute 202f of FIG. 2 and/or AV compute 400 of FIG. 4), a remote AV system (such as remote AV system 114 of FIG. 1), a fleet management system (such as fleet management system 116 of FIG. 1), and a V2I system (such as V2I system 118 of FIG. 1). In one or more examples, the system 500 can be for operating an autonomous vehicle.

In one or more embodiments or examples, the system 500 is in communication with and/or includes one or more of: a device (such as device 300 of FIG. 3), a localization system (such as localization system 406 of FIG. 4), a planning system (the planning system 404 of FIG. 4), a perception system (such as the perception system 504 of FIG. 5A and/or the perception system 402 of FIG. 4), a database (such as database 410 of FIG. 4 and/or database 508 of FIG. 5A) and a control system (such as the control system 408 of FIG. 4).

In one or more embodiments or examples, the system 500 includes at least one processor, and at least one memory storing instructions thereon that, when executed by the at least one processor, cause the at least one processor to perform operations. In one or more embodiments or examples, the operations include obtaining map data 505 indicative of an environment in which an autonomous vehicle 550 can operate. In one or more embodiments or examples, the map data 505 includes a plurality of lane connectors associated with an intersection in the environment. In one or more embodiments or examples, the operations include obtaining data 507 associated with at least one agent in the environment indicative of the agent relative to the environment. In one or more embodiments or examples, the operations include determining a trajectory 511 of the at least one agent relative to the environment based on the data 507 associated with at least one agent. In one or more embodiments or examples, the operations include matching the trajectory 511 of the at least one agent with one lane connector of the plurality of lane connectors to determine a matched trajectory 513. In one or more embodiments or examples, the operations include determining a traffic light parameter indicative of a status of a traffic light of the intersection based on the matched trajectory 513.

In other words, the system 500 obtains environmental data as well as data indicative of any agents within the environment. In some examples, system 500 determines the status of traffic lights (e.g., whether a traffic light is green or red) using trajectories (such as trajectories 511 of FIG. 5B) of the agents (including the autonomous vehicle 550 that the system 500 is a part of). For example, the map data 505 includes a plurality of lane connectors illustrating potential paths through an intersection. By matching trajectories of agents with the lane connectors, the system 500 can infer the traffic light status. As an example, if the system 500 determines that agents are taking trajectories 511 passing through an intersection, the system 500 determines (e.g., through inference) that the traffic light status is green for those the lanes the agents are travelling through. As another example, if all agents have a trajectory 511 of being stopped, the system 500 determines (e.g., through inference) that the traffic light status is red for those lanes where the agents are travelling in. The system 500 can perform these determinations online, through the use of sensor data 509, and/or offline for training and improvements of determinations by the system 500. In the case of offline use, the system 500 can develop a dataset of inferences that can later be used to train one or more machine learning models based on the determinations made by the system 500.

In one or more examples or embodiments, the system 500 is used for training and/or validating downstream planning and prediction models conditioned on the traffic light status. The disclosed system 500 allows a realistic simulation of the traffic from all directions.

In one or more embodiments or examples, the system 500 obtains the map data 505 from a database 508 (such as database 410 of FIG. 4). The database 508 can be within the system 500, or from a separate server in communication with the system 500. In some example, map data 505 is a ground truth map of the environment of which the autonomous vehicle 550 can operate. In other words, the map data 505 is an area of the environment where the autonomous vehicle 550 is currently operating. The map data 505 is obtained from an offline source and/or from an online source. In one or more example or embodiments, the map data 505 is indicative of drivable areas of an environment, such as roads, crosswalks, driveways, parking lots, etc.

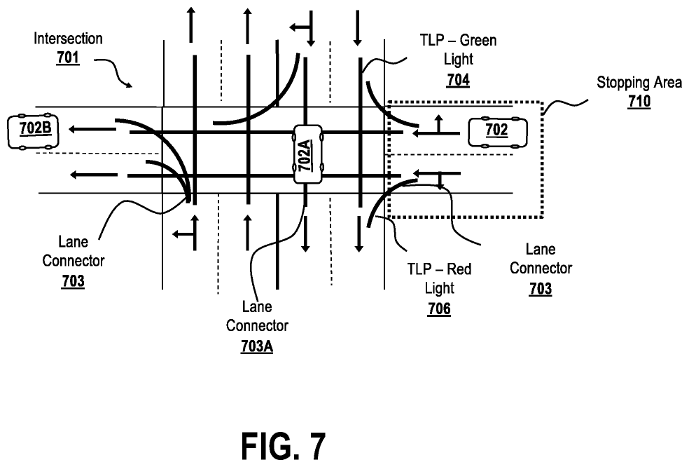

In one or more embodiments or examples, the map data 505 includes a plurality of lane connectors. Examples of lane connectors are illustrated in FIG. 7. In particular, the map data 505 may include lane connectors at one or more intersections indicated by the map data 505. In some examples, the lane connectors are indicative of one or more potential paths an agent and/or the autonomous vehicle 550 can take at an intersection. As examples, the lane connectors are indicative of a stop, right turn, left turn, straight path, etc. that an agent may take through an intersection. The lane connectors can be indicative of any maneuver (e.g., a U-turn) within an intersection. In one or more examples or embodiments, the system 500 is configured to filter out lane connectors which do not correspond to the nearest intersection to the autonomous vehicle 550.

In one or more examples or embodiments, the system 500 obtains information indicative of agents in the environment, such as via data 507 associated with the at least one agent. An agent can be considered any object in the environment capable of dynamic movement. Examples of agents include pedestrians, vehicles, and bicycles. The data, in some examples, is indicative of the agent relative to the environment. In one or more examples or embodiments, the data includes one or more of: position, orientation, speed, and direction of the agent. In some examples, the system 500 construes the autonomous vehicle 550 itself as an agent in the environment. For example, the system 500 determines data associated with the autonomous vehicle 550 using localization data from a localization system (such as localization system 406 of FIG. 4). In an example, the system 500 determines other agents in the environment based on perception data from the perception system (such as perception system 402 of FIG. 4), such as from sensor data 509 generated from sensors 510. The system 500, in some examples, obtains the data 507 associated with the at least one agent for all lanes and all directions at a particular intersection.

In one or more examples or embodiments, the system 500 obtains the data 507 associated with the at least one agent from a database 508 (such as database 410 of FIG. 4). Accordingly, the system 500 may not obtain data 507 associated with at least one agent from a sensor 510. For example, the data 507 associated with at least one agent is indicative of past routes and/or trajectories taken by agents at an intersection (e.g., recorded intersection data).

In one or more embodiments or examples, the system 500 determines a trajectory 511 of the at least one agent relative to the environment. For example, the system 500 includes a trajectory generator 512 (which may be part of a perception system 504 and/or a planning system 506) configured to determine a trajectory 511 of the at least one agent. The perception system 504 can obtain map data 505 and the data 507 associated with at least one agent. In some examples, the perception system 504 transmits the map data 505 and data 507 associated with at least one agent to planning system 506, such as shown in FIG. 5A. In certain examples, the planning system 506 outputs plan data 520, which is received as input by a trajectory generator 512. In one or more examples or embodiments, the plan data 520 is indicative of predicted or planned trajectories of the agent. For examples, the system 500 determines a trajectory 511 of each agent of the at least one agent in the environment (e.g., the trajectory generator 512 generates a trajectory 511). For example, the trajectory of the at least one agent is determined based on the data 507 associated with the at least one agent. In some examples, the trajectory 511 is one or more of: a past trajectory, a present trajectory, and predicted (e.g., future) trajectory.

In one or more examples or embodiments, the system 500 is configured to match the trajectories 511 with the plurality of lane connectors of the map data 505. As an example, the system 500 includes a system 514 that matches the trajectory 511 with a lane connector that is the closest in the environment relative to the trajectory 511. In one or more examples or embodiments, the system 500 uses the directed Hausdorff distance between the trajectory 511 and all lane connectors of the plurality of lane connectors to find the best matching lane connector (e.g., the closest). The directed Hausdorff distance provides a distance between two subsets of a metric space wherein the first subset is indicative of the trajectory 511 and the second subset is indicative of the lane connectors. In one or more examples or embodiments, the system 500 compares directed Hausdorff distance to a threshold to obtain the best matching lane connector. The best matching lane connector can be seen as the lane connector with the closest distance to the trajectory 511. The system 500 is configured to provide a matched trajectory 513 for the at least one agent in some examples. The matched trajectory 513 may be equivalent to one lane connector of the plurality of lane connectors.

In one or more examples or embodiments, the system 500 determines a traffic light parameter based on the matched trajectory 513. For example, the system 500 includes a traffic light status generator 518 configured to determine the traffic light parameter based on the matched trajectory 513. In some examples, the traffic light parameter is associated with a lane connector. For example, the traffic light parameter is indicative of a status of a traffic light at an intersection. In one or more examples or embodiments, the traffic light parameter is indicative of a traffic light being green, a traffic light being red, or an unknown traffic light state. For example, the system 500 determines the traffic light parameter indicative of a red light based on the system 500 determining a trajectory 511 matches a trajectory stopping at an intersection (e.g., matched trajectory 513). For example, a trajectory 511 matched to a lane connector passing through an intersection is used to determine a traffic light parameter indicative of a green light. However, a trajectory 511 matched to a lane connector of a right hand turn at an intersection may not be sufficient to determine a green or red light, as the turn would be legal in both cases, and therefore the system 500 may determine the traffic parameter as indicative of an unknown traffic light state.

When initializing the system 500, in certain examples or embodiments, all traffic light parameters are set to be indicative of an unknown traffic light state. The system 500 can be configured to update the traffic light parameters as more data is obtained. In one or more examples or embodiments, the traffic light parameters are stored in association with lane connectors rather than storing the traffic light status alone. For example, a traffic light parameter can be indicative of lane connectors where vehicles stop at the intersection. In some examples, the system 500 updates the association of the plurality of lane connectors with the relevant traffic light parameters of the intersection.

In one or more examples or embodiments, system 500 uses many different types of criteria when the system 500 is determining the traffic light parameter. These criteria can vary based on the type of agent (e.g., vehicle, bicycle, pedestrian), and can include different ways of determining how the agent is reacting with respect to the intersection. In some examples, these criteria allow for filtering out (e.g., removing, discarding) of non-relevant agents for more efficient analysis of an intersection. If the agent parameter does not meet the criterion, the agent is filtered out. If the agent parameter does meet the criterion, the agent is not filtered out and the process continues. Filtering out agents can advantageously result in improved performance. For example, the system 500 may only match non-filtered out agents with one lane connector. The following provide non-limiting illustrative examples of such criteria, each with particular advantages.

In one or more embodiments or examples, matching the trajectory 511 includes determining an agent parameter of the at least one agent based on the trajectory 511. In one or more embodiments or examples, matching the trajectory 511 includes determining whether the agent parameter meets a criterion. In one or more embodiments or examples, matching the trajectory 511 includes filtering out the at least one agent in response to determining that the agent parameter does not meet a criterion. In one or more embodiments or examples, matching the trajectory 511 includes not filtering out the at least one agent in response to determining that the agent parameter meets a criterion. In one or more embodiments or examples, matching the trajectory 511 with the one lane connector includes matching the trajectory 511 of at least one non-filtered out agent of the at least one agent with the one lane connector.

In one or more embodiments or examples, the agent parameter includes a class parameter indicative of the at least one agent being a vehicle, a bicycle, or a pedestrian. In one or more embodiments or examples, determining if the agent parameter meets the criterion includes determining if the class parameter is indicative of the at least one agent being a pedestrian. In one or more embodiments or examples, determining if the agent parameter meets the criterion includes determining that the agent parameter does not meet the criterion in response to determining that the class parameter is indicative of a pedestrian. In one or more embodiments or examples, determining if the agent parameter meets the criterion includes determining that the agent parameter meets the criterion in response to determining that the class parameter is not indicative of a pedestrian. In other words, the system 500 is configured to filter out pedestrians who typically are not indicative of traffic light status, but continue analyzing vehicles such as cars, trucks, etc. The system 500 can be configured to determine that the agent parameter does not meet the criterion in response to determining that the class parameter is indicative of a bicycle. If the agent is not one of a vehicle, a bicycle, or a pedestrian, the system 500, in some examples, determines that the agent parameter does not meet the parameter. In some examples, an agent parameter only meets the criterion if the class parameter is indicative of the at least one agent being a vehicle.

In one or more embodiments or examples, determining if the agent parameter meets the criterion includes determining a distance parameter indicative of a distance between the at least one agent and the intersection. In one or more embodiments or examples, determining if the agent parameter meets the criterion includes determining whether the distance parameter is within a first threshold. In one or more embodiments or examples, determining if the agent parameter meets the criterion includes determining that the agent parameter does not meet the criterion in response to determining that the distance parameter is not within the first threshold. In one or more embodiments or examples, determining if the agent parameter meets the criterion includes determining that the agent parameter meets the criterion in response to determining that the distance parameter is within the first threshold. For example, the agent parameter includes the distance parameter. In other words, the system 500 can be configured to use distances between agents and the intersection for determining whether the agent parameter meets or does not meet the criterion. This may be used to filter out agents which are not close enough to the intersection, and therefore may not be useful for the determination of a traffic light signal. The first threshold may be a filter criterion that is based on a particular distance from the intersection. The first threshold can be seen as a distance threshold. For example, the first threshold is one or more of 10 feet, 20 feet, 30 feet, 40 feet, and 50 feet. The first threshold may vary depending on the speed limit of the roads meeting with the intersection. For example, agents on roads having slow speeds may not be affected by a traffic light until closer to the intersection as opposed to agents on roads having higher speed limits due to the necessary stopping time.

In one or more embodiments or examples, determining if the agent parameter meets the criterion includes determining a time parameter indicative of a time that the at least one agent would be within the intersection. In one or more embodiments or examples, determining if the agent parameter meets the criterion includes determining whether the time parameter satisfies a time threshold. In one or more embodiments or examples, determining if the agent parameter meets the criterion includes determining that the agent parameter does not meet the criterion in response to determining that the time parameter is below the time threshold. In one or more embodiments or examples, determining if the agent parameter meets the criterion includes determining that the agent parameter meets the criterion in response to determining that the time parameter satisfies the time threshold. For example, the agent parameter includes the time parameter. In other words, the system 500 can determine whether the agent parameter meets or does not meet the criterion by using the time during which an agent is in the intersection. This may be used to filter out agents which are already passing through the intersection, or are currently passing through the intersection, which may not provide proper indication of a traffic light. For example, when the time parameter is indicative of a duration that is not too short (such as in seconds), the agent parameter would meet the criterion. The time threshold can be expressed in seconds.

In one or more embodiments or examples, determining if the agent parameter meets the criterion includes determining a distance between a starting position and an ending position of the trajectory 511. In one or more embodiments or examples, determining if the agent parameter meets the criterion includes determining whether the distance between the starting position and the ending position satisfies a second threshold. In one or more embodiments or examples, determining if the agent parameter meets the criterion includes determining that the agent parameter does not meet the criterion in response to determining that the distance does not satisfy the second threshold. In one or more embodiments or examples, determining if the agent parameter meets the criterion includes determining that the agent parameter meets the criterion, in response to determining that the distance satisfies the second threshold. In other words, the system 500 can determine whether the agent parameter meets or does not meet the criterion by using a distance between a trajectory's starting and ending position. For example, the system 500 determines whether a start and end of the trajectory (e.g. past and/or future waypoints which are within the target intersection) is sufficiently far apart to ensure that the agent moves sufficiently. Stated differently, for example, when an agent doesn't move enough, then the data is discarded by the system by the agent.

In one or more embodiments or examples, determining if the agent parameter meets the criterion includes determining an agent position parameter indicative of a position of the at least one agent with respect to the intersection. In other words, the agent parameter includes an agent position parameter indicative of a position of the at least one agent with respect to the intersection. In one or more embodiments or examples, determining if the agent parameter meets the criterion includes determining whether the agent position parameter satisfies a stopline distance from the intersection. For example, the system 500 determines that the stopline distance is satisfied when the agent position parameter indicates that the agent is at a distance from the intersection greater than the stopline distance. For example, the system 500 determines that the stopline distance is not satisfied when the agent position parameter indicates that the agent is at a distance from the intersection less than or equal to the stopline distance. In one or more embodiments or examples, determining if the agent parameter meets the criterion includes determining whether the agent position parameter is indicative of the at least one agent being in a traffic lane of the intersection. In one or more embodiments or examples, determining if the agent parameter meets the criterion includes determining that the agent parameter does not meet the criterion in response to determining that the agent position parameter does not satisfy the stopline distance. In one or more embodiments or examples, determining if the agent parameter meets the criterion includes determining that the agent parameter meets the criterion in response to determining that the agent position parameter satisfies the stopline distance. In one or more embodiments or examples, determining if the agent parameter meets the criterion includes determining that the agent parameter does not meet the criterion in response to determining that the agent position parameter is not indicative of the at least one agent being in the traffic lane of the intersection. In one or more embodiments or examples, determining if the agent parameter meets the criterion includes determining that the agent parameter meets the criterion in response to determining that the agent position parameter is indicative of the at least one agent being in the traffic lane of the intersection. For example, the agent position parameter is based on one or more of a front, a back, and a center of an agent. Each lane of an intersection can have a stopline associated with it. The stopline distance can be indicative of a stopping area. In other words, the system 500 is configured to determine whether an agent is before or after a stopline distance (e.g., does the agent position parameter satisfy the stopline distance) as an example. In some examples, when the agent does not satisfy the stopline distance, the system 500 filters out the agent. In one or more examples or embodiments, the system 500 further determines whether the agent is in a lane of the intersection. An agent may be passing outside of an intersection, or may be travelling in a way that the agent's trajectory 511 would not intersect with the intersection. These agents may not be relevant to the traffic light status analysis, and can be filtered out. It may be appreciated that the criterion of the stopline distance (e.g., between starting and ending point of a trajectory) is to reduce false matches of overly short trajectories.

In some embodiments, the system 500 is configured to determine whether the traffic light parameter is indicative of a green light or indicative of a red light. In one or more embodiments or examples, determining the traffic light parameter includes determining whether the matched trajectory 513 of the at least one agent is within the intersection. In one or more embodiments or examples, determining the traffic light parameter includes determining the traffic light parameter as indicative of a green light in response to determining that the matched trajectory 513 is within the intersection. In one or more embodiments or examples, determining the traffic light parameter includes not determining the traffic light parameter as indicative of a green light in response to determining that the matched trajectory 513 is not within the intersection. In other words, the system 500 is configured to determine whether the at least one agent is within the intersection at a particular time in certain examples. Stated differently, the system 500 crops the trajectory to be within the intersection. In some examples, the system 500 can use a center of the at least one agent for determining whether the at least one agent is in the intersection. If the at least one agent is within the intersection, the system 500 is configured to determine the traffic light parameter as indicative of green in some examples. For example, the system 500 determines that the at least one agent is legally passing through an intersection, and accordingly determines (e.g., infers) that a traffic light is green to allow traffic through the intersection.

In one or more embodiments or examples, determining the traffic light parameter includes determining whether the at least one agent is located within a stopping area of the intersection. In one or more embodiments or examples, determining the traffic light parameter includes determining whether a velocity of the at least one agent satisfies a velocity threshold in response to determining that the at least one agent is located within the stopping area. In one or more embodiments or examples, determining the traffic light parameter includes not determining whether a velocity of the at least one agent satisfies a velocity threshold in response to determining that the at least one agent is not located within the stopping area. In one or more embodiments or examples, determining the traffic light parameter includes determining the traffic light parameter as indicative of a red light in response to determining that the velocity satisfies the velocity threshold and that the traffic light parameter is not indicative of a green light. In one or more embodiments or examples, determining the traffic light parameter includes not determining the traffic light parameter as indicative of a red light in response to determining that the velocity does not the velocity threshold or that the traffic light parameter is indicative of a green light. The determination of a traffic light parameter as indicative of a red light can be more complicated than the determination of a traffic light parameter as indicative of green light.

In one or more examples or embodiments, the system 500 is configured to determine whether the at least one agent is located within a stopping area of the intersection. A stopping area may be predefined in the system 500. The stopping area may be an area defined by the stop line distance, for example an area where the agent is intended to reside before proceeding through an intersection. The stopping area may be indicative of a normal stopping area at an intersection. If the system 500 determines that the agent is not located within the stopping area, the system 500 may not proceed to determining a traffic light parameter as indicative of a red light. If the agent is within the stopping area, the system 500 then determines whether a velocity (e.g., speed) of the at least one agent satisfies a velocity threshold in some examples. The velocity threshold may be maximum speed that the agent has in the stopping area. This can eliminate agents in the stopping area that are able to proceed as normal through the intersection, which would not be a red light. The velocity threshold may be a particular set speed and/or a particular speed under a speed limit of the road. The velocity satisfies the velocity threshold if the velocity is below the velocity threshold. The velocity does not satisfy the velocity threshold if the velocity is at or above the velocity threshold. In one or more examples or embodiments, if the system 500 determines the at least one agent to be within the stopping area and below the velocity threshold, the system 500 determines the traffic light parameter as indicative of a red light.

In one or more embodiments or examples, matching the trajectory 511 with the one lane connector includes determining a plurality of matching parameters indicative of a distance between the trajectory 511 and each lane connector of the plurality of lane connectors. In one or more embodiments or examples, matching the trajectory 511 with the one lane connector includes matching the trajectory 511 with the lane connector of the plurality of lane connectors having the lowest matching parameter of the plurality of matching parameters. For example, the system 500 is configured to compare the trajectory 511 of the at least one agent with each lane connector of the plurality of lane connectors. As there may likely be many different lane connectors (e.g., a plurality of lane connectors), each trajectory 511 for the agent will include a plurality of different matching parameters. For example, a matching parameter is indicative of a distance between the trajectory 511 and a particular lane connector. For example, the matching parameter include the distance between the trajectory and each lane connector. A directed Hausdorff distance can be used for determining the distance. In one or more examples or embodiments, the system 500 determines the overall gap (e.g., area) between the trajectory 511 and the particular lane connector for the matching parameter. A lower matching parameter can be indicative of a closer match between the trajectory 511 and a lane connector. The system 500 matches (e.g., selects) the lane connector of the plurality of lane connector with the lowest (e.g., smallest, closest match) associated matching parameter in certain examples.

In one or more embodiments or examples, matching the trajectory 511 with the one lane connector includes obtaining movement data indicative of past movement of the at least one agent. In one or more embodiments or examples, matching the trajectory 511 includes matching the trajectory 511 with the at least one lane connector based on the movement data. Movement data can be stored in a database 508 (such as database 410 of FIG. 4). In some examples, the system 500 uses the movement data to take into account slow reaction times of drivers. The system 500 includes a machine learning model which uses movement data for improvements on prediction of trajectories 511 in some examples. In some examples, for offline perception, the system uses actual movement data from past, present and future instances. In one or more examples or embodiments, the system 500 matches the trajectory 511 with a lane connector by using the movement data.

In one or more embodiments or examples, matching the trajectory 511 with the one lane connector includes determining a predicted movement parameter indicative of a predictive movement of the at least one agent. In one or more embodiments or examples, matching the trajectory 511 includes matching the trajectory 511 with the at least one lane connector based on the predictive movement parameter. For example, the system 500 predicts, in the perception system 504 (such as using the perception system 402 of FIG. 4) and/or in the planning system 506 (such as using the planning system 404 of FIG. 4), the trajectory 511 and/or matches 514 the trajectory 511 with the lane connector using the predicted movement parameter. In some examples, the system 500 utilizes machine learning techniques or models to determine the predicted movement parameter. The predictive movement parameter can be based on the movement data.

In one or more embodiments or examples, obtaining the data 507 associated with the at least one agent includes obtaining data associated with a plurality of agents. In one or more embodiments or examples, determining the trajectory 511 includes determining the trajectory 511 for each of the agents of the plurality of agents. In one or more embodiments or examples, matching the trajectory 511 with one lane connector includes matching the trajectory 511 of each agent of the plurality of agents with one lane connector for provision of a plurality of matched trajectories. In one or more examples or embodiments, the system 500 is configured to obtain data associated with a plurality of agents. In some examples, the system 500 determines a trajectory 511 and then matches the trajectory 511 with one lane connector for each corresponding agent of the plurality of agents.

In one or more embodiments or examples, the intersection includes a plurality of traffic lights. In one or more embodiments or examples, the operations include grouping trajectories of each agent which are parallel in directions. In one or more embodiments or examples, the operations include matching the grouped trajectories with corresponding lane connectors. Advantageously, grouping can improve processing efficiency as the system 500 only needs to calculate one of the groups. Matched grouped trajectories are indicative of trajectories that are parallel (or generally parallel) in some examples. As parallel trajectories can share the same traffic light status, the system 500 can group them together for provision of a matched group trajectory. Then, instead of each trajectory 511 being compared by the system 500 to a lane connector, the system 500 may only have to match each grouped trajectory with a lane connector. In one or more embodiments or examples, determining the traffic light parameter includes determining the traffic light parameter for each traffic light of the plurality of traffic lights based on matched grouped trajectories. In other words, the system 500 is configured to determine the status of many different traffic lights at a given intersection as an example. For example, a four way intersection may have at least four different traffic lights, and potentially more if restricted left turns and/or right turns are used.

In one or more embodiments or examples, determining the traffic light parameter includes determining a current traffic light parameter based on a previously determined traffic light parameter. For example, the system 500 uses a post-processing backfilling to account for the slow reaction time of drivers. If it is advantageous for the system 500 to avoid traffic light parameters as “unknown”, the system 500 is configured to determine (e.g., estimate) of a current traffic light parameter based on a previous traffic light parameter in some examples.

In one or more embodiments or examples, the operations further include obtaining sensor data 509 indicative of the environment. In one or more embodiments or examples, obtaining the map data 505 includes obtaining the map data 505 based on the sensor data 509. In one or more embodiments or examples, obtaining the data 507 associated with the at least one agent includes obtaining the data 507 associated with the at least one agent based on the sensor data 509. For example, the system 500 is configured to act online on the autonomous vehicle 550. In one or more examples or embodiments, the system 500 obtains the sensor data 509 via a perception system 504 (such as perception system 402 of FIG. 4). For example, the system 500 obtains the sensor data 509 from one or more sensors 510 of the autonomous vehicle 550 (such as one or more of cameras 202a, LiDAR sensors 202b, radar sensors 202c, and microphones 202d of FIG. 2). In one or more examples, the system 500 obtains the map data 505 based on the sensor data 509. This may provide a more accurate understanding of the environment. In one or more examples, the system 500 obtains data 507 associated with the at least one agent based on the sensor data 509. This may allow the autonomous vehicle 550 to operate in real-time, and can actively determine agent statuses and trajectories 511. The perception system 504 is configured to obtain the sensor data 509 in some examples.

In one or more examples or embodiments, the sensor data 509 is one or more of: radar sensor data, camera sensor data, image sensor data, audio sensor, and LIDAR sensor data. The particular type of sensor data is not limiting. The sensor data 509 can be indicative of an environment around an autonomous vehicle. For example, the sensor data 509 is indicative of an object (such as agent), and/or a plurality of objects, in the environment around an autonomous vehicle.

In one or more examples or embodiments, sensor 510 can be one or more sensors, such as an onboard sensor. The sensor 510 can be associated with the autonomous vehicle. An autonomous vehicle can include one or more sensors that can be configured to monitor an environment where the autonomous vehicle operates, such as via the sensor 510, through sensor data 509. Sensors can include one or more of the sensors illustrated in FIG. 2.

In one or more embodiments or examples, the operations further include determining an autonomous vehicle trajectory based on the traffic light parameter as shown in FIG. 5B. In one or more embodiments or examples, the operations further include providing data 522 associated with the autonomous vehicle trajectory (e.g., to a control system similar to or the same as control system 408 of FIG. 4). The data 522 associated with the autonomous vehicle trajectory can be control data (e.g., for controlling and/or operating the autonomous vehicle). In one or more embodiments or examples, the data 522 associated with the autonomous vehicle trajectory is configured to cause operation of the autonomous vehicle along the autonomous vehicle trajectory. In other words, the system 500 is configured to provide operational information to the vehicle 550. The system 500 can be configured to determine a trajectory of the autonomous vehicle 550 based on the traffic light parameter. For example, the trajectory is determined as being associated with a stop and/or deceleration of the vehicle based on a traffic light parameter indicative of a red light. As another example, the trajectory is determined as being associated with continued movement and/or acceleration of the vehicle based on a traffic light parameter indicative of a green light.

In one or more examples or embodiments, causing (e.g., controlling) operation includes generating, based on the data associated with the AV trajectory, control data for a control system of an autonomous vehicle 550. In one or more examples or embodiments, causing (e.g., controlling) operation includes to provide control data to a control system of an autonomous vehicle 550. In one or more examples or embodiments, causing (e.g., controlling) operation includes transmitting control data to, e.g., a control system of an autonomous vehicle 550 and/or an external system. In one or more examples or embodiments, causing (e.g., controlling) operation includes controlling, based on control data, a control system of an autonomous vehicle 550 and/or an external system. In one or more examples or embodiments, the system is optimized for performance. For example, a speed bottleneck occurs with repeated matching of all trajectories 511 with lane connectors. In embodiments, the system is configured to timestamp matched trajectories 513. Consecutive timestamps for matched trajectories 513 can reuse previously determined matching. Consecutive timestamps can be time stamps within 10, 9, 8, 7, 6, 5, 4, 3, 2, or 1 seconds.

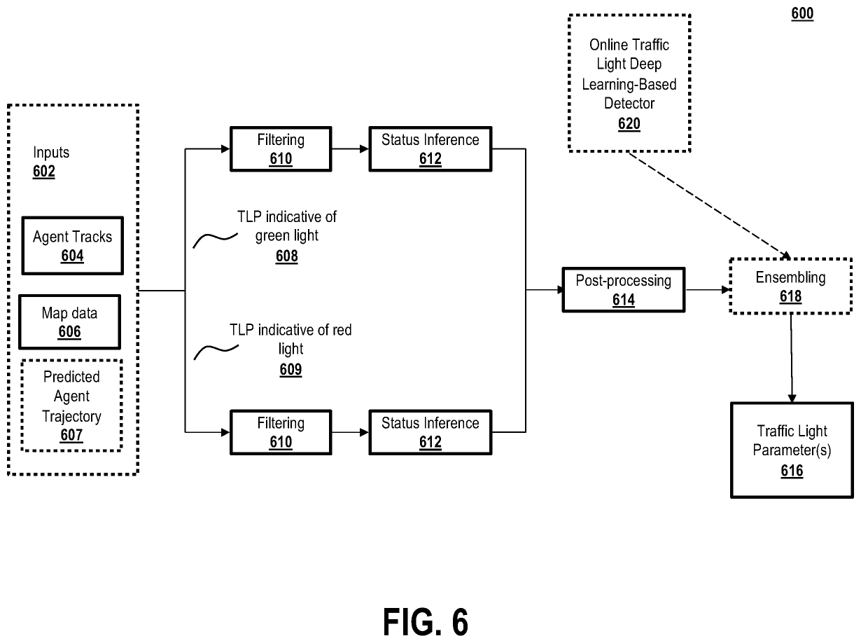

FIG. 6 is a diagram of an example implementation of a process 600 for determining a traffic light parameter via offline and/or online perception motion inference. In one or more embodiments or examples, the process 600 is performed by system 500 of FIGS. 5A-5B. The inputs 602 of the process 600 include map data 606 and data indicative of an agent (indicated as agent tracks 604 in FIG. 6), and/or predicted agent trajectory 607. In one or more examples or embodiments, the process 600 involves determining a traffic light parameter (TLP) inference either indicative of a green light 608 or indicative of a red light 609 based on the inputs 602. Regardless of the determination, the process 600 can filter 610 non-relevant agents, such as pedestrians, as discussed above with respect to FIGS. 5A-5B. In some examples, the process 600 includes updating the status inference 612 as needed based on any performed filtering 610. Further, the process 600 involves applying any post-processing 614 needed, including any grouping and/or backfilling as discussed herein, in some examples. In one or more examples or embodiments, the process 600 involves determining a final traffic light parameter 616, such as a traffic light parameter indicative of a particular traffic light status. For online inference, the system carrying out the process 600 for example includes an online traffic light deep learning-based detector 620 (e.g., a detector inference, e.g. a vision-based online traffic light detector), which is used as input for ensembling 618 (e.g. aggregating) with output from the status inference to provide the traffic light parameters 616. The ensembling 618 can be seen as aggregating the matched trajectory with the detector inference data from 620 for determining the traffic light parameter, e.g., via weighted averages, bagging, boosting, training of machine learning model. In 618, an ensemble technique is applied to the matched trajectory and the detector inference data from 620. The traffic light parameter is for example determined by determining a first confidence parameter indicative of confidence level of the matched trajectory (e.g. using the directed Hausdorff distance for green lights, deviation from 0 speed for red lights) and by determining a second confidence parameter indicative of a confidence level of the detector inference data; and by aggregating the matched trajectory with the detector inference data for determining the traffic light parameter based on the first confidence parameter and/or the second confidence parameter (e.g., ensembling, using the confidence parameters).

Further, these techniques can allow for an improved labelling of traffic lights by inferring their labels from past trajectories of surrounding actors, and optionally future trajectories for offline perception motion inference. The disclosed method is lightweight and fast (and hence, can be used online) and can serve as an ensembling tool for a deep learning-based traffic light detector. This can improve the performance of the overall traffic light detection system.

FIG. 7 is a diagram of an example implementation of a process for determining a traffic light parameter via offline and/or online perception motion inference, such as performed by system 500 of FIGS. 5A-5B and system 600 of FIG. 6. The implementation shown in FIG. 7 can be performed either offline or online (e.g., with sensor data). As shown in the example of FIG. 7, the system obtains map data indicative of the environment (e.g., intersection 701) and data indicative of at least one agents in the environment, shown as vehicles 702, 702A, 702B. The map data includes a plurality of lane connectors 703 illustrated as lines passing through intersection 701. For sake of clarity, FIG. 7 additional includes arrows indicating direction of traffic through intersection 701. Each of the agents 702, 702A, 702B can have a determined trajectory, which is then matched to a particular lane connector 703. For example, as shown agent 702A is would be matched with the straight lane connector 703A passing through the intersection 701. Based on this matched trajectory, the traffic light parameter 704 of the lanes parallel to agent 702A can be indicative of a green light.

Further, FIG. 7 illustrates agent 702 located within a stopping area 710 with a velocity of 0. As the traffic light parameter for the lane in which the agent 702 is located in is not green, the agent 702 is located within the stopping area 710, and the velocity of the agent 702 is 0, the traffic light parameter 706 is determined as indicative of a red light.

Referring now to FIG. 8, illustrated is a flowchart of a method or process 800 for offline perception motion inference, such as for operating and/or controlling an AV. The method can be performed by a system disclosed herein, such as an AV compute 202f of FIG. 2 and AV compute 400 of FIG. 4, a vehicle 102, 200, of FIGS. 1 and 2, respectively, device 300 of FIG. 3, system 500 of FIGS. 5A-5B, process 600 of FIG. 6, and implementation of FIG. 7. The system disclosed can include at least one processor which can be configured to carry out one or more of the operations of method 800. The method 800 can be performed (e.g., completely, partially, and/or the like) by another device or group of devices separate from or including system disclosed herein.

In one or more embodiments or examples, the method 800 includes obtaining, at step 802, using at least one processor, map data indicative of an environment in which an autonomous vehicle can operate. In one or more embodiments or examples, the map data includes a plurality of lane connectors associated with an intersection in the environment. For example, the lane connectors are obtained from map data. In one or more embodiments or examples, the method 800 includes obtaining, at step 804, using the at least one processor, data associated with at least one agent in the environment, the data being indicative of the agent relative to the environment. In one or more embodiments or examples, the method 800 includes determining, at step 806, using the at least one processor, a trajectory of the at least one agent relative to the environment based on the data. For example, the trajectory of the at least one agent is determined based on the data associated with the at least one agent. In one or more embodiments or examples, the method 800 includes matching, at step 808, using the at least one processor, the trajectory of the at least one agent with one lane connector of the plurality of lane connectors to determine a matched trajectory. In one or more embodiments or examples, the method 800 includes determining, at step 810, using the at least one processor a traffic light parameter indicative of a status of a traffic light of the intersection based on the matched trajectory. The traffic light parameter can be a lane connector. The status of the traffic light includes (e.g., green lights and/or red lights). Advantageously, the method 800 can be performed offline using offline data, such as from a database. The plurality of lane connectors, in some examples, are indicative of potential paths the autonomous vehicle and/or agents can take at an intersection. Example lane connectors include a right turn, a left turn, and a proceed straight ahead. The method 800 can include filtering out lanes which are not incoming to the nearest signaled intersection to the autonomous vehicle.

In one or more examples or embodiments, data associated with the at least one agent include past and future trajectories (e.g., agent tracks). For examples, the data includes data for all lanes and all directions. A localization system (such as localization system 406 of FIG. 4) can be used for obtaining data on the autonomous vehicle. The method 800 can operate on a closed loop or an open loop. The method 800 uses direct Hausdorff distance for matching the trajectory with the one lane connector in some examples.

In one or more embodiments or examples, matching, at step 808, the trajectory includes determining an agent parameter of the at least one agent based on the trajectory. In one or more embodiments or examples, matching, at step 808, the trajectory includes determining whether the agent parameter meets a criterion. In one or more embodiments or examples, matching, at step 808, the trajectory includes, in response to determining that the agent parameter does not meet a criterion, filtering out the at least one agent. In one or more embodiments or examples, matching, at step 808, the trajectory includes, in response to determining that the agent parameter meets a criterion, not filtering out the at least one agent. In one or more embodiments or examples, matching, at step 808, the trajectory with the one lane connector includes matching the trajectory of at least one non-filtered out agent of the at least one agent with the one lane connector. Filtering out the at least one agent includes removing and/or discarding the agent in certain examples. Example criteria are discussed below. Example criteria include whether a center of the agent is sufficiently within the target intersection, whether a duration of trajectory is not too short, whether a start and end trajectory is sufficiently far apart.

In one or more embodiments or examples, the agent parameter includes a class parameter indicative of the at least one agent being a vehicle, a bicycle or a pedestrian. In one or more embodiments or examples, determining if the agent parameter meets the criterion includes determining if the class parameter is indicative of the at least one agent being a pedestrian. In one or more embodiments or examples, determining if the agent parameter meets the criterion includes, in response to determining that the class parameter is indicative of a pedestrian, determining that the agent parameter does not meet the criterion. In one or more embodiments or examples, determining if the agent parameter meets the criterion includes, in response to determining that the class parameter is not indicative of a pedestrian, determining that the agent parameter meets the criterion. In other words, the method 800 filters out pedestrians, but pays attention to vehicles such as cars, trucks, etc. In one or more embodiments or examples, determining if the agent parameter meets the criterion includes determining a distance parameter indicative of a distance between the at least one agent and the intersection. In one or more embodiments or examples, determining if the agent parameter meets the criterion includes determining whether the distance parameter is within a first threshold. In one or more embodiments or examples, determining if the agent parameter meets the criterion includes, in response to determining that the distance parameter is not within the first threshold, determining that the agent parameter does not meet the criterion. In one or more embodiments or examples, determining if the agent parameter meets the criterion includes, in response to determining that the distance parameter is within the first threshold, determining that the agent parameter meets the criterion. In other words, the method 800 filters out whether an agent is in an intersection, or close enough. In one or more embodiments or examples, determining if the agent parameter meets the criterion includes determining a time parameter indicative of a time that the at least one agent would be within the intersection. In one or more embodiments or examples, determining if the agent parameter meets the criterion includes determining whether the time parameter satisfies a time threshold. In one or more embodiments or examples, determining if the agent parameter meets the criterion includes, in response to determining that the time parameter is below the time threshold, determining that the agent parameter does not meet the criterion. In one or more embodiments or examples, determining if the agent parameter meets the criterion includes, in response to determining that the time parameter is equal to or above the time threshold, determining that the agent parameter meets the criterion.

In one or more embodiments or examples, determining if the agent parameter meets the criterion includes determining a distance between a starting position and an ending position of the trajectory. In one or more embodiments or examples, determining if the agent parameter meets the criterion includes determining whether the distance between the starting position and the ending position satisfies a second threshold. In one or more embodiments or examples, determining if the agent parameter meets the criterion includes, in response to determining that the distance does not satisfy the second threshold, determining that the agent parameter does not meet the criterion. In one or more embodiments or examples, determining if the agent parameter meets the criterion includes, in response to determining that the distance satisfies the second threshold, determining that the agent parameter meets the criterion. In one or more embodiments or examples, determining if the agent parameter meets the criterion includes determining an agent position parameter indicative of a position of the at least one agent with respect to the intersection. In one or more embodiments or examples, determining if the agent parameter meets the criterion includes determining whether the agent position parameter satisfies a stop line distance from the intersection. In one or more embodiments or examples, determining if the agent parameter meets the criterion includes determining whether the agent position parameter is indicative of the at least one agent being in a traffic lane of the intersection. In one or more embodiments or examples, determining if the agent parameter meets the criterion includes, in response to determining that the agent position parameter does not satisfy the stop line distance, determining that the agent parameter does not meet the criterion. In one or more embodiments or examples, determining if the agent parameter meets the criterion includes, in response to determining that the agent position parameter satisfies the stop line distance, determining that the agent parameter meets the criterion. In one or more embodiments or examples, determining if the agent parameter meets the criterion includes, in response to determining that the agent position parameter is not indicative of the at least one agent being in the traffic lane of the intersection, determining that the agent parameter does not meet the criterion. In one or more embodiments or examples, determining if the agent parameter meets the criterion includes, in response to determining that the agent position parameter is indicative of the at least one agent being in the traffic lane of the intersection, determining that the agent parameter meets the criterion.

In one or more embodiments or examples, determining, at step 810, the traffic light parameter includes determining whether the matched trajectory of the at least one agent is within the intersection. In one or more embodiments or examples, determining, at step 810, the traffic light parameter includes, in response to determining that the matched trajectory is within the intersection, determining the traffic light parameter as indicative of a green light. In one or more embodiments or examples, determining, at step 810, the traffic light parameter includes, in response to determining that the matched trajectory is not within the intersection, not determining the traffic light parameter as indicative of a green light. In one or more embodiments or examples, determining, at step 810, the traffic light parameter includes determining whether the at least one agent is located within a stopping area of the intersection. In one or more embodiments or examples, determining, at step 810, the traffic light parameter includes, in response to determining that the at least one agent is located within the stopping area, determining whether a velocity of the at least one agent satisfies a velocity threshold. In one or more embodiments or examples, determining, at step 810, the traffic light parameter includes, in response to determining that the at least one agent is not located within the stopping area, not determining whether a velocity of the at least one agent satisfies a velocity threshold. In one or more embodiments or examples, determining, at step 810, the traffic light parameter includes, in response to determining that the velocity satisfies the velocity threshold and that the traffic light parameter is not indicative of a green light, determining the traffic light parameter as indicative of a red light. In one or more embodiments or examples, determining, at step 810, the traffic light parameter includes, in response to determining that the velocity does not the velocity threshold or that the traffic light parameter is indicative of a green light, not determining the traffic light parameter as indicative of a red light. In some examples or embodiments, the stopping area is a location where vehicles typically stop for a red light. The stopping area can be predefined.

In one or more embodiments or examples, matching, at step 808, the trajectory with the one lane connector includes determining a plurality of matching parameters indicative of a distance between the trajectory and each lane connector of the plurality of lane connectors. In one or more embodiments or examples, matching, at step 808, the trajectory with the one lane connector includes matching the trajectory with the lane connector of the plurality of lane connectors having the lowest matching parameter of the plurality of matching parameters. The method 800 can utilize a closest match for determining the proper matching. For example, the method 800 uses a Hausdorff distance.

In one or more embodiments or examples, matching, at step 808, the trajectory with the one lane connector includes obtaining movement data indicative of past movement of the at least one agent. In one or more embodiments or examples, matching, at step 808, the trajectory includes matching the trajectory with the at least one lane connector based on the movement data. In one or more embodiments or examples, matching, at step 808, the trajectory with the one lane connector includes determining a predicted movement parameter indicative of a predictive movement of the at least one agent. In one or more embodiments or examples, matching, at step 808, the trajectory includes matching the trajectory with the at least one lane connector based on the predictive movement parameter. In one or more embodiments or examples, obtaining, at step 804, the data associated with the at least one agent includes obtaining data associated with a plurality of agents. In one or more embodiments or examples, determining, at step 806, the trajectory includes determining the trajectory for each of the agents of the plurality of agents. In one or more embodiments or examples, matching, at step 808, the trajectory with one lane connector includes matching the trajectory of each agent of the plurality of agents with one lane connector for provision of a plurality of matched trajectories.

The method 800 can use certain post-processing, as discussed herein. In one or more embodiments or examples, the intersection includes a plurality of traffic lights. In one or more embodiments or examples, the method 800 includes grouping trajectories of the trajectory of each agent which are parallel directions. In one or more embodiments or examples, the method 800 includes matching the grouped trajectories with corresponding lane connectors. In one or more embodiments or examples, determining, at step 810, the traffic light parameter includes determining the traffic light parameter for each traffic light of the plurality of traffic lights based on the matched grouped trajectories. The map data can be indicative of information on traffic lights that go in a “parallel” direction and therefore share the same traffic light status as indicated by the traffic light parameter. The method 800 can use this information to set all traffic lights in a parallel direction to have the same status. In one or more embodiments or examples, determining, at step 810, the traffic light parameter includes determining a current traffic light parameter based on a previously determined traffic light parameter. For examples, the method 800 uses post-processing backfilling after a certain time for slow-starting drivers. The method 800 updates the current traffic light parameter to take the value of the previous traffic light parameter, in particular to take into account the slow reaction time of the drivers, where the traffic light parameter is determined green/red light status from a past time window.

In one or more examples or embodiments, the method 800 is performed online. In one or more embodiments or examples, the method 800 further includes obtaining sensor data indicative of the environment. In one or more embodiments or examples, obtaining, at step 802, the map data includes obtaining the map data based on the sensor data. In one or more embodiments or examples, obtaining, at step 804, the data associated with the at least one agent includes obtaining the data associated with the at least one agent based on the sensor data. For example, the sensor data includes LiDAR sensor data, camera sensor data, and/or radar sensor data. In one or more embodiments or examples, the method 800 further includes determining an autonomous vehicle trajectory based on the traffic light parameter. In one or more embodiments or examples, the method 800 further includes providing, using the at least one processor, data associated with the autonomous vehicle trajectory. In one or more embodiments or examples, the data associated with the autonomous vehicle trajectory is configured to cause operation of the autonomous vehicle along the autonomous vehicle trajectory.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Disclosed are non-transitory computer readable media comprising instructions stored thereon that, when executed by at least one processor, cause the at least one processor to carry out operations according to one or more of the methods disclosed herein.

Also disclosed are methods, non-transitory computer readable media, and systems according to any of the following items:
Item 1. A method comprising:
obtaining, using at least one processor, map data indicative of an environment in which an autonomous vehicle can operate, the map data comprising a plurality of lane connectors associated with an intersection in the environment;
obtaining, using the at least one processor, data associated with at least one agent in the environment indicative of the agent relative to the environment;
determining, using the at least one processor, a trajectory of the at least one agent relative to the environment based on the data;
matching, using the at least one processor, the trajectory of the at least one agent with one lane connector of the plurality of lane connectors to determine a matched trajectory; and
determining, using the at least one processor, a traffic light parameter indicative of a status of a traffic light of the intersection based on the matched trajectory.
Item 2. The method of item 1, wherein matching the trajectory comprises:
determining an agent parameter of the at least one agent;
determining whether the agent parameter meets a criterion based on the trajectory; and in response to determining that the agent parameter does not meet a criterion, filtering out the at least one agent;
wherein matching the trajectory with the one lane connector comprises matching the trajectory of at least one non-filtered out agent of the at least one agent with the one lane connector.
Item 3. The method of item 2, wherein the agent parameter comprises a class parameter indicative of the at least one agent being a vehicle, a bicycle or a pedestrian; wherein determining if the agent parameter meets the criterion comprises:
determining if the class parameter is indicative of the at least one agent being a pedestrian; and
in response to determining that the class parameter is indicative of a pedestrian, determining that the agent parameter does not meet the criterion.
Item 4. The method of any of items 2-3, wherein determining if the agent parameter meets the criterion comprises:
determining a distance parameter indicative of a distance between the at least one agent and the intersection;
determining whether the distance parameter is within a first threshold; and in response to determining that the distance parameter is not within the first threshold, determining that the agent parameter does not meet the criterion.
Item 5. The method of any of items 2-4, wherein determining if the agent parameter meets the criterion comprises:
determining a time parameter indicative of a time that the at least one agent would be within the intersection;
determining whether the time parameter satisfies a time threshold; and in response to determining that the time parameter is below the time threshold, determining that the agent parameter does not meet the criterion.
Item 6. The method of any of items 2-5, wherein determining if the agent parameter meets the criterion comprises:
determining a distance between a starting position and an ending position of the trajectory;
determining whether the distance between the starting position and the ending position satisfies a second threshold; and
in response to determining that the distance does not satisfy the second threshold, determining that the agent parameter does not meet the criterion.
Item 7. The method of any of items 2-6, wherein determining if the agent parameter meets the criterion comprises:
determining an agent position parameter indicative of a position of the at least one agent with respect to the intersection;
determining whether the agent position parameter satisfies a stopline distance from the intersection;
determining whether the agent position parameter is indicative of the at least one agent being in a traffic lane of the intersection; and
in response to determining that the agent position parameter does not satisfy the stopline distance or the agent position parameter is not indicative of the at least one agent being in the traffic lane of the intersection, determining that the agent parameter does not meet the criterion.
Item 8. The method of any of the previous items, wherein determining the traffic light parameter comprises:
determining whether the matched trajectory of the at least one agent is within the intersection; and
in response to determining that the matched trajectory is within the intersection, determining the traffic light parameter as indicative of a green light.
Item 9. The method of item 8, wherein determining the traffic light parameter comprises: determining whether the at least one agent is located within a stopping area of the intersection;
in response to determining that the at least one agent is located within the stopping area, determining whether a velocity of the at least one agent satisfies a velocity threshold; and
in response to determining that the velocity satisfies the velocity threshold and that the traffic light parameter is not indicative of a green light, determining the traffic light parameter as indicative of a red light.
Item 10. The method of any of the preceding items, wherein matching the trajectory with the one lane connector comprises:
determining a plurality of matching parameters indicative of a distance between the trajectory and each lane connector of the plurality of lane connectors; and matching the trajectory with the lane connector of the plurality of lane connectors having the lowest matching parameter of the plurality of matching parameters.
Item 11. The method of any one of the previous items, wherein matching the trajectory with the one lane connector comprises:
obtaining movement data indicative of past movement of the at least one agent; wherein matching the trajectory comprises matching the trajectory with the at least one lane connector based on the movement data.
Item 12. The method of any one of the previous items, wherein matching the trajectory with the one lane connector comprises:
determining a predicted movement parameter indicative of a predictive movement of the at least one agent;
wherein matching the trajectory comprises matching trajectory with the at least one lane connector based on the predictive movement parameter.
Item 13. The method of any one of the previous items, further comprising:
obtaining the data associated with the at least one agent comprises obtaining data associated with a plurality of agents;
determining the trajectory comprises determining the trajectory for each of the agents of the plurality of agents; and
matching the trajectory with the one lane connector comprises matching the trajectory of each agent of the plurality of agents with the one lane connector for provision of a plurality of matched trajectories.
Item 14. The method of item 13, wherein the intersection comprises a plurality of traffic lights, wherein the method comprises:
grouping trajectories of the trajectory of each agent which are parallel directions; and matching the grouped trajectories with corresponding lane connectors.
Item 15. The method of item 14, wherein determining the traffic light parameter comprises:
determining the traffic light parameter for each traffic light of the plurality of traffic lights based on the plurality of matched grouped trajectories.
Item 16. The method of item 15, wherein determining the traffic light parameter comprises:
determining a current traffic light parameter based on a previously determined traffic light parameter.
Item 17. The method of any one of the previous items, further comprising:
obtaining sensor data indicative of the environment;
wherein obtaining the map data comprises obtaining the map data based on the sensor data; and wherein obtaining the data associated with the at least one agent comprises obtaining the data associated with the at least one agent based on the sensor data.
Item 18. The method of item 17, further comprising:
determining an autonomous vehicle trajectory based on the traffic light parameter; and providing, using the at least one processor, data associated with the autonomous vehicle trajectory, the data associated with the autonomous vehicle trajectory configured to cause operation of the autonomous vehicle along the autonomous vehicle trajectory.
Item 18a. The method of any one of items 17-18, wherein obtaining the data associated with the at least one agent comprises:
   predicting a future trajectory of the at least one agent; and
   including the future trajectory in the data associated with the at least one agent.
Item 18b. The method of any one of items 17-18a, wherein determining the traffic light parameter comprises:
   obtaining detector inference data indicative of the status of the traffic light; and
   aggregating the matched trajectory with the detector inference data for determining the traffic light parameter.
Item 18c. The method of item 18b, wherein aggregating the matched trajectory with the detector inference data comprises applying an ensemble technique to the matched trajectory and the detector inference data.
Item 18d. The method of any of claims 18b-18c, wherein determining the traffic light parameter comprises:
   determining a first confidence parameter indicative of confidence level of the matched trajectory;
   determining a second confidence parameter indicative of a confidence level of the detector inference data; and
   aggregating the matched trajectory with the detector inference data for determining the traffic light parameter based on the first confidence parameter and/or the second confidence parameter.
Item 19. A non-transitory computer readable medium comprising instructions stored thereon that, when executed by at least one processor, cause the at least one processor to carry out operations comprising:
obtaining map data indicative of an environment in which an autonomous vehicle can operate, the map data comprising a plurality of lane connectors associated with an intersection in the environment;
obtaining data associated with at least one agent in the environment indicative of the agent relative to the environment;
determining a trajectory of the at least one agent relative to the environment based on the data;
matching the trajectory of the at least one agent with one lane connector of the plurality of lane connectors to determine a matched trajectory; and
determining a traffic light parameter indicative of a status of a traffic light of the intersection based on the matched trajectory.
Item 20. The non-transitory computer readable medium of item 19, wherein matching the trajectory comprises:
determining an agent parameter of the at least one agent;
determining whether the agent parameter meets a criterion based on the trajectory; and in response to determining that the agent parameter does not meet a criterion, filtering out the at least one agent;
wherein matching the trajectory with the one lane connector comprises matching the trajectory of at least one non-filtered out agent of the at least one agent with the one lane connector.
Item 21. The non-transitory computer readable medium of item 20, wherein the agent parameter comprises a class parameter indicative of the at least one agent being a vehicle, a bicycle or a pedestrian; wherein determining if the agent parameter meets the criterion comprises:
determining if the class parameter is indicative of the at least one agent being a pedestrian; and
in response to determining that the class parameter is indicative of a pedestrian, determining that the agent parameter does not meet the criterion.
Item 22. The non-transitory computer readable medium of any of items 20-21, wherein determining if the agent parameter meets the criterion comprises:
determining a distance parameter indicative of a distance between the at least one agent and the intersection;
determining whether the distance parameter is within a first threshold; and
in response to determining that the distance parameter is not within the first threshold, determining that the agent parameter does not meet the criterion.
Item 23. The non-transitory computer readable medium of any of items 20-22, wherein determining if the agent parameter meets the criterion comprises:
determining a time parameter indicative of a time that the at least one agent would be within the intersection;
determining whether the time parameter satisfies a time threshold; and in response to determining that the time parameter is below the time threshold, determining that the agent parameter does not meet the criterion.
Item 24. The non-transitory computer readable medium of any of items 20-23, wherein determining if the agent parameter meets the criterion comprises:
   determining a distance between a starting position and an ending position of the trajectory;
determining whether the distance between the starting position and the ending position satisfies a second threshold; and
in response to determining that the distance does not satisfy the second threshold, determining that the agent parameter does not meet the criterion.
Item 25. The non-transitory computer readable medium of any of items 20-24, wherein determining if the agent parameter meets the criterion comprises:
determining an agent position parameter indicative of a position of the at least one agent with respect to the intersection;
determining whether the agent position parameter satisfies a stopline distance from the intersection;
determining whether the agent position parameter is indicative of the at least one agent being in a traffic lane of the intersection; and
in response to determining that the agent position parameter does not satisfy the stopline distance or the agent position parameter is not indicative of the at least one agent being in the traffic lane of the intersection, determining that the agent parameter does not meet the criterion.
Item 26. The non-transitory computer readable medium of any of items 19-25, wherein determining the traffic light parameter comprises:
determining whether the matched trajectory of the at least one agent is within the intersection; and
in response to determining that the matched trajectory is within the intersection, determining the traffic light parameter as indicative of a green light.
Item 27. The non-transitory computer readable medium of item 26, wherein determining the traffic light parameter comprises:
determining whether the at least one agent is located within a stopping area of the intersection;
in response to determining that the at least one agent is located within the stopping area, determining whether a velocity of the at least one agent satisfies a velocity threshold; and
in response to determining that the velocity satisfies the velocity threshold and that the traffic light parameter is not indicative of a green light, determining the traffic light parameter as indicative of a red light.
Item 28. The non-transitory computer readable medium of any of items 19-27, wherein matching the trajectory with the one lane connector comprises:
determining a plurality of matching parameters indicative of a distance between the trajectory and each lane connector of the plurality of lane connectors; and
matching the trajectory with the lane connector of the plurality of lane connectors having the lowest matching parameter of the plurality of matching parameters.
Item 29. The non-transitory computer readable medium of any of items 19-28, wherein matching the trajectory with the one lane connector comprises:
obtaining movement data indicative of past movement of the at least one agent;
wherein matching the trajectory comprises matching the trajectory with the at least one lane connector based on the movement data.
Item 30. The non-transitory computer readable medium of any of items 19-29, wherein matching the trajectory with the one lane connector comprises:
determining a predicted movement parameter indicative of a predictive movement of the at least one agent;
wherein matching the trajectory comprises matching the trajectory with the at least one lane connector based on the predictive movement parameter.
Item 31. The non-transitory computer readable medium of any of items 19-30, further comprising:
obtaining the data associated with the at least one agent comprises obtaining data associated with a plurality of agents;
determining the trajectory comprises determining the trajectory for each of the agents of the plurality of agents; and
matching the trajectory with one lane connector comprises matching the trajectory of each agent of the plurality of agents with one lane connector for provision of a plurality of matched trajectories.
Item 32. The non-transitory computer readable medium of item 31, wherein the intersection comprises a plurality of traffic lights, wherein the non-transitory computer readable medium comprises:
grouping trajectories of the trajectory of each agent which are parallel directions; and matching the grouped trajectories with corresponding lane.
Item 33. The non-transitory computer readable medium of item 32, wherein determining the traffic light parameter comprises:
determining the traffic light parameter for each traffic light of the plurality of traffic lights based on matched grouped trajectories.
Item 34. The non-transitory computer readable medium of item 33, wherein determining the traffic light parameter comprises:
determining a current traffic light parameter based on a previously determined traffic light parameter.
Item 35. The non-transitory computer readable medium of any of items 19-34, further comprising:
obtaining sensor data indicative of the environment;
wherein obtaining the map data comprises obtaining the map data based on the sensor data; and
wherein obtaining the data associated with the at least one agent comprises obtaining the data associated with the at least one agent based on the sensor data.
Item 36. The non-transitory computer readable medium of item 35, further comprising: determining an autonomous vehicle trajectory based on the traffic light parameter; and providing data associated with the autonomous vehicle trajectory, the data associated with the autonomous vehicle trajectory configured to cause operation of the autonomous vehicle along the autonomous vehicle trajectory.
Item 37. A system, comprising at least one processor; and at least one memory storing instructions thereon that, when executed by the at least one processor, cause the at least one processor to perform operations comprising:
obtaining map data indicative of an environment in which an autonomous vehicle can operate, the map data comprising a plurality of lane connectors associated with an intersection in the environment;
obtaining data associated with at least one agent in the environment indicative of the agent relative to the environment;
determining a trajectory of the at least one agent relative to the environment based on the data;
matching the trajectory of the at least one agent with one lane connector of the plurality of lane connectors to determine a matched trajectory; and
determining a traffic light parameter indicative of a status of a traffic light of the intersection based on the matched trajectory.
Item 38. The system of item 37, wherein matching the trajectory comprises:
determining an agent parameter of the at least one agent based on the trajectory;
determining whether the agent parameter meets a criterion; and
in response to determining that the agent parameter does not meet a criterion, filtering out the at least one agent;
wherein matching the trajectory to the one lane connector comprises matching the trajectory of at least one non-filtered out agent of the at least one agent with the one lane connector.
Item 39. The system of item 38, wherein the agent parameter comprises a class parameter indicative of the at least one agent being a vehicle, a bicycle or a pedestrian;
wherein determining if the agent parameter meets the criterion comprises:
determining if the class parameter is indicative of the at least one agent being a pedestrian; and
in response to determining that the class parameter is indicative of a pedestrian, determining that the agent parameter does not meet the criterion.
Item 40. The system of any of items 38-39, wherein determining if the agent parameter meets the criterion comprises:
determining a distance parameter indicative of a distance between the at least one agent and the intersection;
determining whether the distance parameter is within a first threshold; and
in response to determining that the distance parameter is not within the first threshold, determining that the agent parameter does not meet the criterion.
Item 41. The system of any of items 38-40, wherein determining if the agent parameter meets the criterion comprises:
determining a time parameter indicative of a time that the at least one agent would be within the intersection;
determining whether the time parameter satisfies a time threshold; and
in response to determining that the time parameter is below the time threshold, determining that the agent parameter does not meet the criterion.
Item 42. The system of any of items 38-41, wherein determining if the agent parameter meets the criterion comprises:
determining a distance between a starting position and an ending position of the trajectory;
determining whether the distance between the starting position and the ending position satisfies a second threshold; and
in response to determining that the distance does not satisfy the second threshold, determining that the agent parameter does not meet the criterion.
Item 43. The system of any of items 38-42, wherein determining if the agent parameter meets the criterion comprises:
determining an agent position parameter indicative of a position of the at least one agent with respect to the intersection;
determining whether the agent position parameter satisfies a stopline distance from the intersection;
determining whether the agent position parameter is indicative of the at least one agent being in a traffic lane of the intersection; and
in response to determining that the agent position parameter does not satisfy the stopline distance or the agent position parameter is not indicative of the at least one agent being in the traffic lane of the intersection, determining that the agent parameter does not meet the criterion.
Item 44. The system of any of items 37-43, wherein determining the traffic light parameter comprises:
determining whether the matched trajectory of the at least one agent is within the intersection; and
in response to determining that the matched trajectory is within the intersection, determining the traffic light parameter as indicative of a green light.
Item 45. The system of item 44, wherein determining the traffic light parameter comprises:
determining whether the at least one agent is located within a stopping area of the intersection;
in response to determining that the at least one agent is located within the stopping area, determining whether a velocity of the at least one agent satisfies a velocity threshold; and
in response to determining that the velocity satisfies the velocity threshold and that the traffic light parameter is not indicative of a green light, determining the traffic light parameter as indicative of a red light.
Item 46. The system of any of items 37-45, wherein matching the trajectory with the one lane connector comprises:
determining a plurality of matching parameters indicative of a distance between the trajectory and each lane connector of the plurality of lane connectors; and
matching the trajectory with the lane connector of the plurality of lane connectors having the lowest matching parameter of the plurality of matching parameters.
Item 47. The system of any of items 37-46, wherein matching the trajectory with the one lane connector comprises:
obtaining movement data indicative of past movement of the at least one agent;
wherein matching the trajectory comprises matching the trajectory with the at least one lane connector based on the movement data.
Item 48. The system of any of items 37-47, wherein matching the trajectory with the one lane connector comprises:
determining a predicted movement parameter indicative of a predictive movement of the at least one agent;
wherein matching the trajectory comprises matching the trajectory with the at least one lane connector based on the predictive movement parameter.
Item 49. The system of any of items 37-48, the operations further comprising: obtaining the data associated with the at least one agent comprises obtaining data associated with a plurality of agents;
determining the trajectory comprises determining the trajectory for each of the agents of the plurality of agents; and
matching the trajectory with one lane connector comprises matching the trajectory of each agent of the plurality of agents with one lane connector for provision of a plurality of matched trajectories.
Item 50. The system of item 49, wherein the intersection comprises a plurality of traffic lights, wherein the operations comprise:
grouping trajectories of the trajectory of each agent which are parallel directions; and matching the grouped trajectories with corresponding lane connectors.
Item 51. The system of item 50, wherein determining the traffic light parameter comprises:
determining the traffic light parameter for each traffic light of the plurality of traffic lights based on matched grouped trajectories.
Item 52. The system of item 51, wherein determining the traffic light parameter comprises:
determining a current traffic light parameter based on a previously determined traffic light parameter.
Item 53. The system of any of items 37-52, the operations further comprising: obtaining sensor data indicative of the environment;
wherein obtaining the map data comprises obtaining the map data based on the sensor data; and
wherein obtaining the data associated with the at least one agent comprises obtaining the data associated with the at least one agent based on the sensor data.
Item 54. The system of item 53, the operations further comprising:
determining an autonomous vehicle trajectory based on the traffic light parameter; and providing, using the at least one processor, data associated with the autonomous vehicle trajectory, the data associated with the autonomous vehicle trajectory configured to cause operation of the autonomous vehicle along the autonomous vehicle trajectory.

What is claimed is:

1. A method comprising:
obtaining, using at least one processor, map data indicative of an environment in which an autonomous vehicle can operate, the map data comprising a plurality of lane connectors associated with an intersection in the environment;
obtaining, using the at least one processor, data indicative of at least one agent in the environment, the data indicative of the at least one agent being further indicative of a location of the agent relative to the environment;
determining, using the at least one processor, a trajectory of the at least one agent relative to the environment based on the data indicative of the at least one agent;
matching, using the at least one processor, the trajectory of the at least one agent with a lane connector of the plurality of lane connectors to determine a matched trajectory; and
determining, using the at least one processor, a traffic light parameter indicative of a status of a traffic light of the intersection based on the matched trajectory.

2. The method of claim 1, wherein matching the trajectory comprises:
determining an agent parameter of the at least one agent based on the trajectory;
determining whether the agent parameter meets a criterion; and
in response to determining that the agent parameter does not meet a criterion, filtering out the at least one agent;
wherein matching the trajectory with the lane connector comprises matching the trajectory of at least one non-filtered out agent of the at least one agent with the lane connector.

3. The method of claim 2, wherein the agent parameter comprises a class parameter indicative of the at least one agent being a vehicle, a bicycle, or a pedestrian; and
wherein determining whether the agent parameter meets the criterion comprises:
determining that the class parameter is indicative of the at least one agent being a pedestrian; and
in response to determining that the class parameter is indicative of the at least one agent being a pedestrian, determining that the agent parameter does not meet the criterion.

4. The method of claim 2, wherein determining whether the agent parameter meets the criterion comprises:
determining a distance parameter indicative of a distance between the at least one agent and the intersection;
determining that the distance parameter is within a first threshold; and
in response to determining that the distance parameter is not within the first threshold, determining that the agent parameter does not meet the criterion.

5. The method of claim 2, wherein determining whether the agent parameter meets the criterion comprises:
determining a time parameter indicative of a time that the at least one agent would be within the intersection;
determining that the time parameter satisfies a time threshold; and
in response to determining that the time parameter is below the time threshold, determining that the agent parameter does not meet the criterion.

6. The method of claim 2, wherein determining whether the agent parameter meets the criterion comprises:
determining a distance between a starting position and an ending position of the trajectory;
determining that the distance between the starting position and the ending position satisfies a second threshold; and
in response to determining that the distance does not satisfy the second threshold, determining that the agent parameter does not meet the criterion.

7. The method of claim 2, wherein determining whether the agent parameter meets the criterion comprises:
determining an agent position parameter indicative of a position of the at least one agent with respect to the intersection;
determining that the agent position parameter satisfies a stopline distance from the intersection;
determining that the agent position parameter is indicative of the at least one agent being in a traffic lane of the intersection; and
in response to determining that the agent position parameter does not satisfy the stopline distance or the agent position parameter is not indicative of the at least one agent being in the traffic lane of the intersection, determining that the agent parameter does not meet the criterion.

8. The method of claim 1, wherein determining the traffic light parameter comprises:
determining that the matched trajectory of the at least one agent is within the intersection; and
in response to determining that the matched trajectory is within the intersection, determining the traffic light parameter as indicative of a green light.

9. The method of claim 8, wherein determining the traffic light parameter comprises:
determining whether the at least one agent is located within a stopping area of the intersection;
in response to determining that the at least one agent is located within the stopping area, determining whether a velocity of the at least one agent satisfies a velocity threshold; and
in response to determining that the velocity satisfies the velocity threshold and that the traffic light parameter is not indicative of a green light, determining the traffic light parameter as indicative of a red light.

10. The method of claim 1, wherein matching the trajectory with the one lane connector comprises:
determining a plurality of matching parameters indicative of a distance between the trajectory and each lane connector of the plurality of lane connectors; and
matching the trajectory with the lane connector of the plurality of lane connectors having the lowest matching parameter of the plurality of matching parameters.

11. The method of claim 1, wherein matching the trajectory with the one lane connector comprises:
obtaining movement data indicative of past movement of the at least one agent;
wherein matching the trajectory comprises matching the trajectory with the at least one lane connector based on the movement data.

12. The method of claim 1, wherein matching the trajectory with the one lane connector comprises:
determining a predicted movement parameter indicative of a predictive movement of the at least one agent;
wherein matching the trajectory comprises matching the trajectory with the at least one lane connector based on the predictive movement parameter.

13. The method of claim 1, wherein:
obtaining the data associated with the at least one agent comprises obtaining data associated with a plurality of agents;
determining the trajectory comprises determining the trajectory for each of the agents of the plurality of agents; and
matching the trajectory with one lane connector comprises matching the trajectory of each agent of the plurality of agents with one lane connector for provision of a plurality of matched trajectories.

14. The method of claim 13, wherein the intersection comprises a plurality of traffic lights, the method further comprising:
grouping trajectories of the trajectory of each agent which are associated with parallel directions; and
matching the grouped trajectories with corresponding lane connectors.

15. The method of claim 14, wherein determining the traffic light parameter comprises:
determining the traffic light parameter for each traffic light of the plurality of traffic lights based on the matched grouped trajectories.

16. The method of claim 13, wherein determining the traffic light parameter comprises:
determining a current traffic light parameter based on a previously determined traffic light parameter.

17. The method of claim 1, further comprising:
obtaining sensor data indicative of the environment in which the autonomous vehicle is operating,
wherein obtaining the map data comprises obtaining the map data based on the sensor data; and
wherein obtaining the data associated with the at least one agent comprises obtaining the data associated with the at least one agent based on the sensor data.

18. The method of claim 17, further comprising:
determining an autonomous vehicle trajectory based on the traffic light parameter; and
providing data indicative of the autonomous vehicle trajectory, the data associated with the autonomous vehicle trajectory configured to cause operation of the autonomous vehicle along the autonomous vehicle trajectory.

19. The method of claim 17, wherein obtaining the data associated with the at least one agent comprises:
predicting a future trajectory of the at least one agent; and
including the future trajectory in the data associated with the at least one agent.

20. The method of claim 17, wherein determining the traffic light parameter comprises:
obtaining detector inference data indicative of the status of the traffic light; and
aggregating the matched trajectory with the detector inference data for determining the traffic light parameter.
